(19) United States
(12) Patent Application Publication
(10) Pub. No.: US 2007/0030845 A1
(43) Pub. Date: Feb. 8, 2007

(54) Channel assignment process

(75) Inventors: Alan M Hill, Woodbridge (GB); Albert Rafel, Ipswich (GB); Terence G Hodgkinson, Woodbridge (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS PUBLIC LTD., CO., London (GB)

(21) Appl. No.: 10/573,250

(22) PCT Filed: Sep. 29, 2004
(86) PCT No.: PCT/GB04/04148

§ 371 Date: Mar. 23, 2006

(30) Foreign Application Priority Data
Sep. 29, 2003 (GB) 0322763.4
Mar. 24, 2004 (GB) 0406661.9

(51) Int. Cl. H04Q 11/00

(52) U.S. Cl. 370/369; 370/431

(57) ABSTRACT

A channel assignment process for a multi-stage switch arrangement having a plurality of inputs arranged in a plurality of logical associations and a plurality of outputs, wherein time-slotted traffic is received by each logical association of inputs is operated on by one or more switching stages arranged to operate only on traffic provided by the respective logical association of inputs, the channel assignment process comprising: for each logical association, aggregating the time-slots carrying traffic from the inputs forming said logical association to form a channel comprising a plurality of logically associated time-slots; determining a path through a spatial switching stage of the switch arrangement arranged to receive a said channel from each of said logical associations of inputs of the switch arrangement; determining a path for each time-slot within each logical association such that a plurality of end-to-end time-space channels are provided for one or more inputs of the switch arrangement to their requested output via said channel through said spatial switching stage of the switch arrangement.

This invention relates to a channel assignment process. In particular, but not exclusively to a channel assignment process for use in a contention resolution scheme for switches and switch arrangements in a communications network.

As is well known to those skilled in the art, switch scheduling schemes can be considered to comprise a matching process, in which cells arriving at a switch arrangement are selectively matched to available destinations, and a channel assignment process in which a channel or path through the switch arrangement for the selected cells is determined. The channel assignment process described herein assumes that where required such a matching has been already performed to match traffic requests for traffic queued at a input of the switch arrangement to certain destinations. Any suitable matching process may be used to perform the matching. This invention complements the frame-based multi-level matching process described in the inventor's co-pending United Kingdom Patent Application GB-A-0322765.9, the contents of which are hereby incorporated by reference, but is generally independent of whatever previous matching scheme has been used to determine which traffic requests are to be granted.

The objective of a scheduling scheme is to minimise contention and so maximise the throughput of the switch arrangement. As desired switching speeds increase (for example above the Terabit per second range) and as the switch port count of a switch arrangement increases, one limitation when seeking to maximise throughput is the computational complexity of the scheduling process, which results from the computational complexity of the matching and/or channel assignment sub-processes.

The channel assignment of the invention seeks to mitigate the level of computational complexity in a channel assignment process for switch arrangements having a relatively high number of inputs and outputs, for example for large scale switch arrangements having of the order of 1024 input and output ports. Here the term switch arrangement usually refers to a plurality of switches arranged in an appropriate configuration permitting the implementation of the channel assignment process. If a switch arrangement comprises integrated components, however, it may be implemented by a single switch.

Whilst the channel assignment process described herein is suitable for use in a scheduling process, it is also widely applicable to the general problems of time-slot and channel assignment in switch arrangements. The technique provides a means for reducing the computing steps required to implement path-searching algorithms, in particular the parallel Clos path-searching algorithm, as applied to the time-slot assignment of cells and packets in frame-based scheduling (and as described by the inventors in International PCT patent application WO 01/67802 entitled “PACKET SWITCHING”, the contents of which are hereby incorporated by reference).

The channel assignment process seeks in particular to provide an aggregated channel assignment technique providing multi-stage buffering and switching in cell and packet switch arrangements in a communications network.

### SUMMARY STATEMENTS OF INVENTION

The aspects of the invention are as set out by the independent claims appended hereto, with the preferred embodiments of the invention as set out the dependent claims, and also as set out below.

As set out in the appended claims, the channel assignment process provides a process for assigning channels for the service requests of a switch arrangement, and more specifically a process for assigning time-slots for the service requests of a switch arrangement. For example, a service request may comprise a request for bandwidth if the switch is a circuit-switch arrangement or a request for bit rate. In other examples, where a packet or cell switch arrangement is provided, however, a service request is typically a request for one or more time-slots to carry a predetermined number of packets or cells from an input to a predetermined output of the switch arrangement.

Another aspect of the invention seeks to provide a multi-stage time-slot assignment process for an input-queued switch arrangement in a communications network, the switch comprising a plurality of N ingress elements and N egress elements, each of the ingress elements having a number L of ingress subelements and each of the egress elements having a plurality L of egress subelements, the switch arrangement being arranged to have L or more real middle stage space switches of size N×N, and having F or more time-slots, the time-slot assignment process between the said ingress subelements and egress subelements comprising the steps of: aggregating F or more time slots from each of a plurality L in number of said ingress subelements to form an ingress element having a plurality LF or more in number of time-space channels which are pooled between the L subelements of each ingress element and the L subelements of each egress element, wherein each time-space channel corresponds to a different logical middle-stage switch of the packet switch arrangement so that the number of logical input elements and logical output elements for which channel assignment is performed through the middle stage of the switch is N; performing time-space channel assignment through the middle stage of the switch between the logical input elements and the logical output elements; providing time-slot interchange capabilities at the 1^{th}, 3^{rd}, 5^{th} stages; and performing time-slot assignment between the ingress subelements of the ingress elements and the logical output ports of the 3^{rd} stage switches through the 2^{nd} stage time-shared space switches, and performing time-slot assignment between the logical input ports of the 5^{th} stage switches and the egress subelements of the egress elements through the 6^{th} stage time-shared space switches.

Preferably, the switch arrangement is arranged to switch cells or packets. Alternatively, the switch arrangement is a circuit switch. Preferably, the switch arrangement is a cell switch arrangement capable of switching packets. Preferably, the switch arrangement further comprises a 7^{th} stage providing a time-slot interchange capability. Preferably, the subelements comprise ports, and the elements comprise aggregations of ports. Preferably, the input-queued switch comprises VOQs which are implemented in random access memory RAM. Preferably, the time-slot assignment process further comprises the recursive decomposition of the three stages in each element into seven stages using the steps indicated in the above aspect.

Another aspect of the invention seeks to provide a channel assignment process for a multi-stage switch arrangement having a plurality of inputs arranged in a plurality of logical associations and a plurality of outputs, wherein time-slotted traffic is received by each logical association of inputs is operated on by one or more switching stages arranged to operate only on traffic provided by the respective logical association of inputs, the channel assignment process comprising: for each logical association, aggregating the time-slots carrying traffic from the inputs forming said logical association to form a channel comprising a plurality of logically associated time-slots; determining a path through a spatial switching stage of the switch arrangement arranged to receive a said channel from each of said logical associations of inputs of the switch arrangement; determining a path for each time-slot within each logical association such that a plurality of end-to-end time-space channels are provided for one or more inputs of the switch arrangement to their requested output via said channel through said spatial switching stage of the switch arrangement.

Preferably, the outputs of the switch arrangement are logically associated with one or more switching stages, and said step of determining a path for each time-slot within each logical association further comprising determining a path within each logical association of the outputs of the switch arrangement such that said plurality of end-to-end time-space channels are provided.

Those skilled in the art will appreciate that the preferred features of the invention as defined above and by the dependent claims may be combined with each other where appropriate in any suitable manner apparent to those skilled in the art and with any of the aspects where appropriate and in any suitable manner apparent to those skilled in the art.

The embodiments of the invention will now be described by way of example with reference to the accompanying drawings in which:

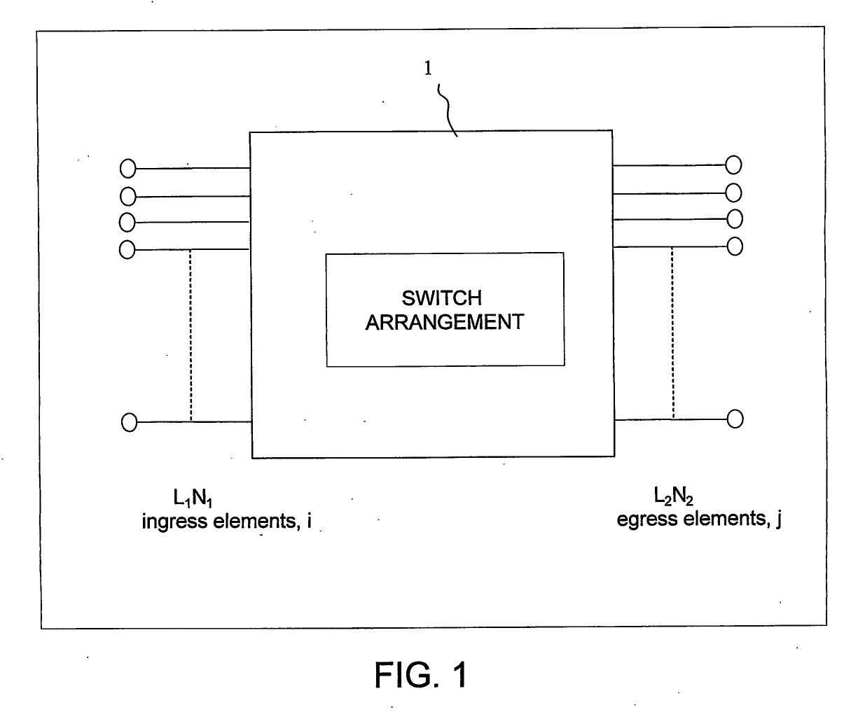

FIG. 1 shows schematically input and output ports of a switch arrangement;

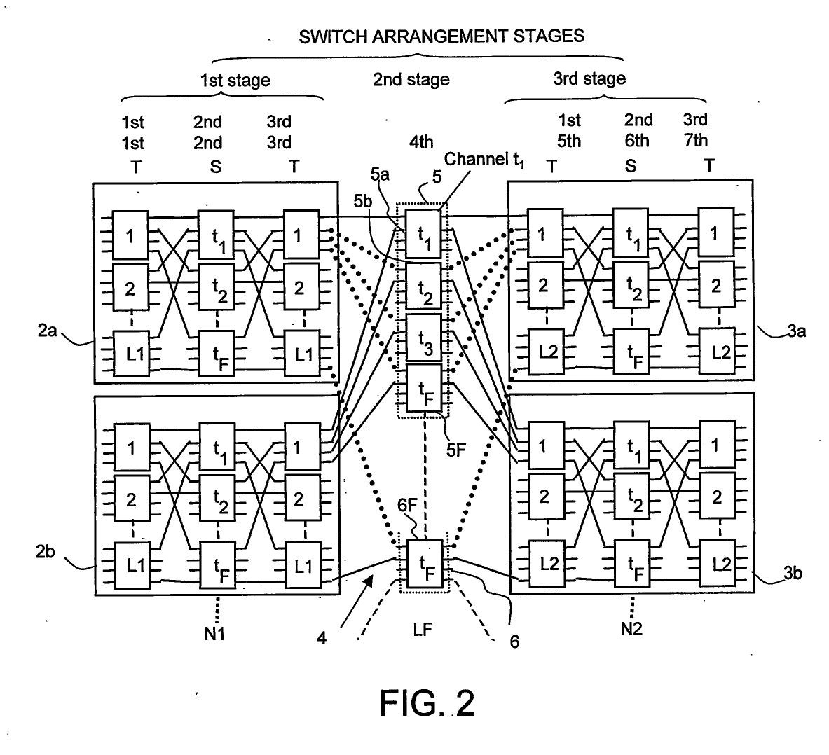

FIG. 2 is a schematic diagram indicating the logical architecture of a switch arrangement suitable for implementing the channel assignment process according to one embodiment of the invention;

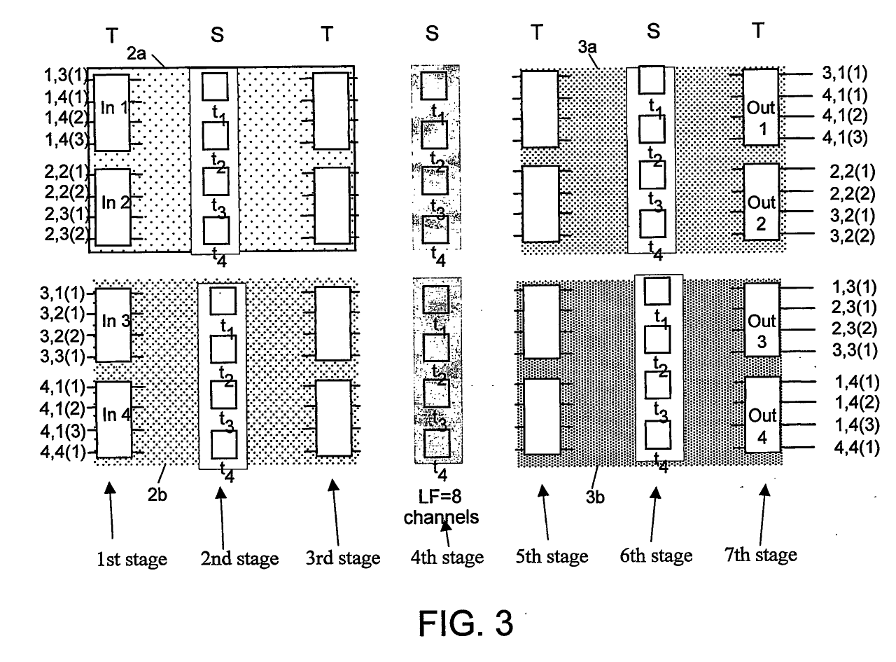

FIG. 3 is a schematic diagram showing the assignment of packets to logical inputs and outputs of the switch arrangement shown in FIG. 2;

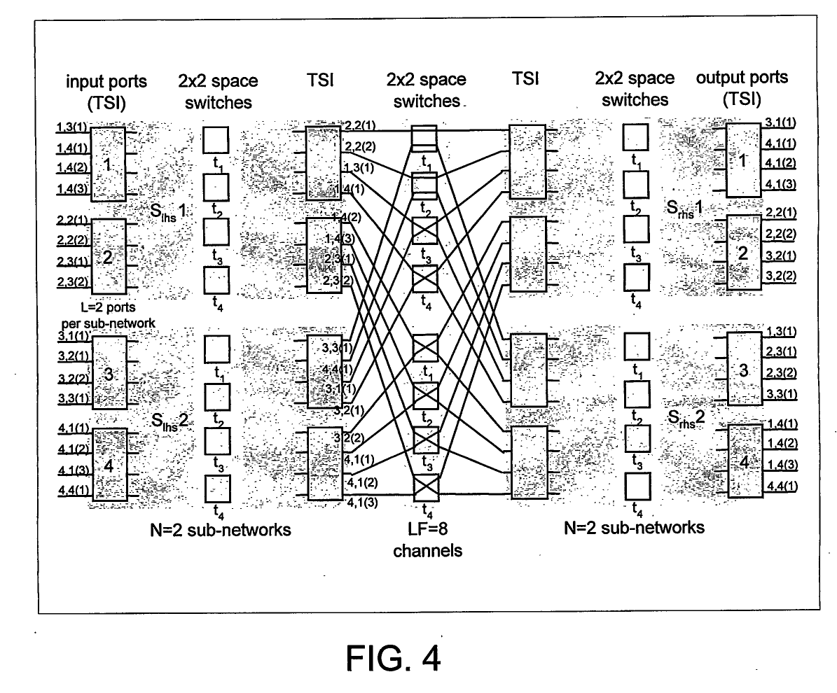

FIG. 4 shows schematically paths and packet assignments after a first path-search phase according to an embodiment of the invention through the switch arrangement shown in FIG. 3;

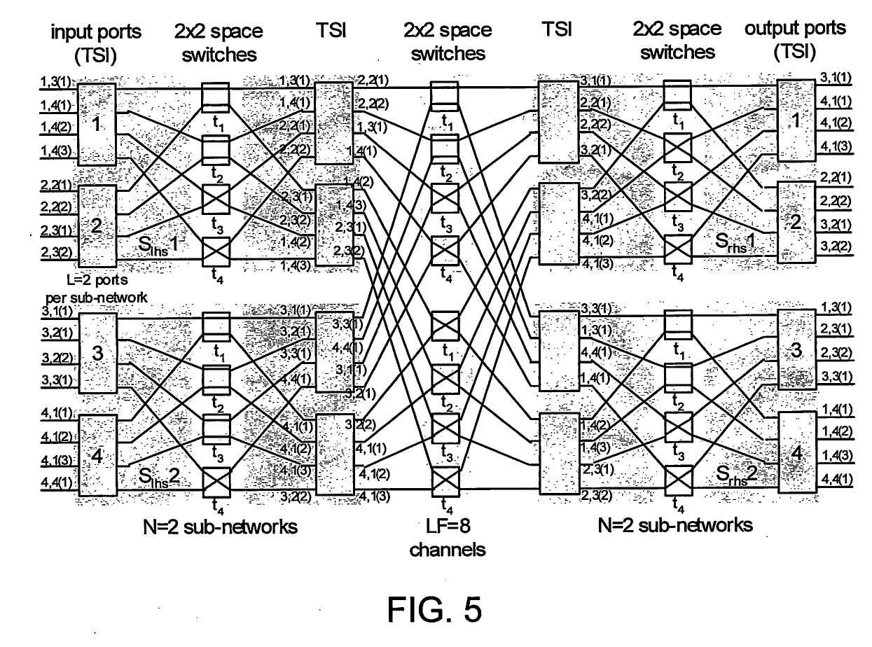

FIG. 5 shows schematically paths and packet assignments after the second path-search phase according to an embodiment of the invention through the switch arrangement shown in FIG. 3;

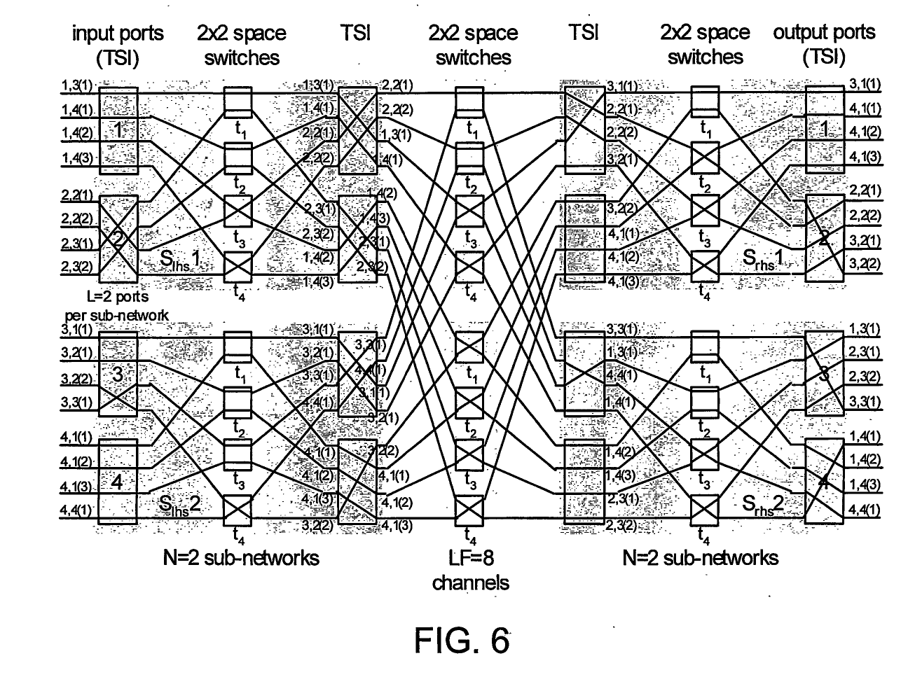

FIG. 6 shows schematically paths assigned to each of the 16 packets through the switch arrangement shown in FIG. 3; and

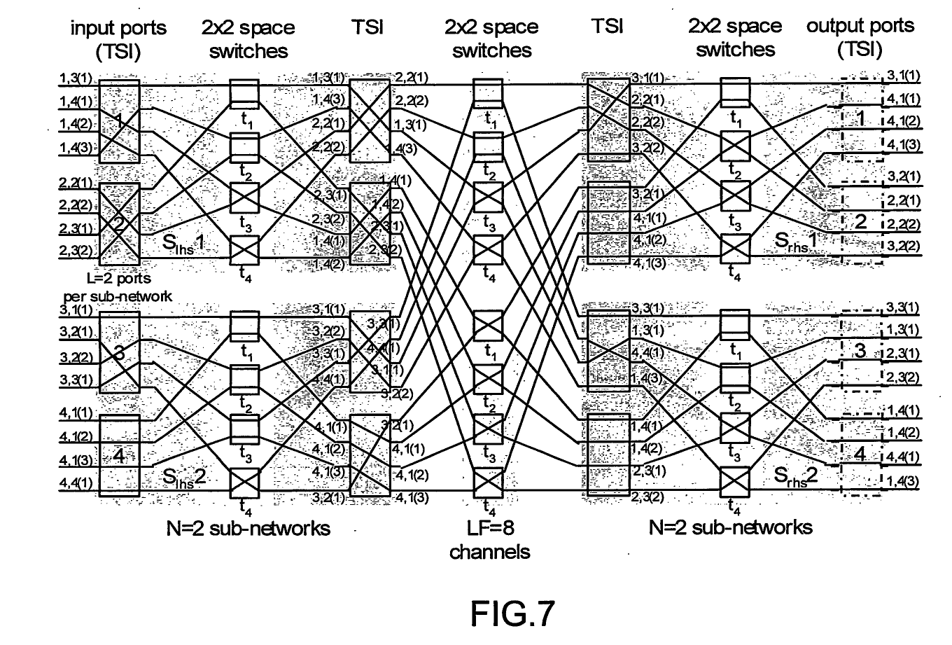

FIG. 7 shows schematically re-ordering of cells or packets to prevent missequencing when the 7^{th}-stage time-slot inter-changers are left out in an embodiment of the invention;.

The best mode of the invention as currently contemplated by the inventors will now be described with reference to the accompanying drawings. Those skilled in the art will recognise that the detailed description provided of specific embodiments of the invention below is not intended to represent the only means of implementing the invention, and that any suitable means which is apparent to a person skilled in the art may be used where appropriate to implement any specific feature of the invention as described. Moreover, the switch arrangements shown schematically in the drawings comprise only very simple arrangements with small numbers of inputs and outputs for reasons of clarity and brevity of explanation.

Referring now to FIG. 1 of the accompanying drawings, a switch arrangement 1 is shown having a number L₁N₁ of ingress subelements (comprising, for example, any suitable input means such as a port, linecard etc), with identities 1≦i≦L₁N₁, and a number L₂N₂ of egress subelements (comprising, for example, any suitable output means such as a port, linecard etc), with identities 1≦j≦L₂N₂. The ingress subelements and egress subelements are arranged in appropriate arrays on either side of a switch fabric as shown in FIG. 1, but those skilled in the art will appreciate that such an arrangement is shown only for clarity, and that other physical and logical arrangements of the ingress and egress subelements are possible. The term “subelement” is used to indicate that a larger logical entity exists comprising an aggregation of a plurality of subelements such as will be described in more detail herein below.

The ingress subelements can comprise any suitably arranged input means providing traffic with ingress to the switch arrangement, and may be unidirectional or bi-directional. Similarly the egress subelements can comprise any suitably arranged output means providing traffic a means of egress from the switch arrangement, and may be unidirectional or bi-directional. Typically the ingress and egress subelements will comprise ports, but where the switch arrangement comprises an array of network elements arranged to switch traffic between two or more ring networks or passive optical networks (PON), the terms ingress and egress subelements may refer any appropriate means of providing ingress and egress.

The L₁N₁×L₂N₂ switch arrangement shown in FIG. 1 can be symmetric (L₁N₁=L₂N₂=LN) or asymmetric (L₁N₁≠L₂N₂) with L₁=L₂ or L₁L₂ and/or N₁=N₂ or N₁ ≠ N₂ in any appropriate combination, providing at each hierarchical level of the channel assignment process (to be described in more detail later) the channels are aggregated appropriately. Where the switch arrangement is not symmetric, those skilled in the art will realise that modifications to the architecture of the switch arrangement described herein can be implemented using any appropriate known means to accommodate the different number of ingress and egress subelements. The number of ingress/egress elements LN can be a relatively large number, for example, L₁N₁ and L₂N₂ may each be of the order of 1024, as mentioned herein above.

In the best mode of the invention currently contemplated by the inventors, the switch arrangement 1 comprises an appropriate switching structure for implementing the channel assignment process of the invention. For example, the switch arrangement may comprise an arrangement of one switch (having a suitable internal switch component structure) or a plurality of switches which are suitably arranged to switch traffic by assigning channels.

In one embodiment of the invention, the switch arrangement can be considered to be a circuit-based switch arrangement in that it provides a path-finding function for traffic through the switch fabric. The switch arrangement can therefore comprise any suitable switch for traffic which requires channel assignment to be implemented, such as, for example, one or more packet switches, and/or one or more switches in a Time Division Multiplexing Network (for example, SDH), and/or comprise one or more a wavelength-switches (for example, for switching whole wavelength channels such as in an optical cross-connect switch arrangement). In this specification, any reference to the term packet is defined to include a reference to any packetised or packet-like traffic, including cell-based traffic. Here a cell comprises a packet having a fixed predetermined length whereas a packet may have a variable structure and/or other differing characteristics such as are well known to those skilled in the art. Those skilled in the art will appreciate that additional means may need to be implemented to modify traffic received by the switch into a form appropriate for switching traffic using the channel assignment process described herein, however, due to the conventional nature of such means which are well known to those skilled in the art, such means are not described herein for reasons of clarity.

For any suitable switch arrangement, the channel assignment process according to the invention determines an end-to-end path through the switch arrangement, i.e. from an ingress subelement to an egress subelement, which makes use of one or more channels assigned through a plurality of internal switching stages of the switch arrangement. A channel may comprise any appropriate medium suitable for the manner in which the switch has been fabricated. Thus a path through the switch arrangement may, for example, comprise a combination of spatial and temporal channels (referred to herein collectively as a time-space channel) through the internal switch structure including a wavelength channel (for example, if the switch supports wavelength division multiplexing (WDM) or dense WDM (DWDM)), or other physical channel means (e.g., if the switch is circuit based) which can be combined appropriately with time channels.

To implement the channel assignment process, a switch arrangement comprises a plurality of switching stages (which may include logical and/or physical switching stages), a sub-set of which are provided within an aggregation element. An ingress aggregation element comprises an aggregation of ingress subelements of the switch arrangement and may further include means for implementing one or more switching stages of the switch arrangement. An egress aggregation element comprises an aggregation of egress subelements of the switch arrangement and may further include means for implementing one or more switching stages of the switch arrangement. Each aggregation of ingress or egress subelements and the associated at least one switching stage are referred to herein as an ingress aggregation (or equivalently as an ingress aggregation element) or an egress aggregation (or equivalently an egress aggregation element) respectively. Each aggregation element thus effectively comprises a switching sub-network of the overall switch arrangement.

Referring to FIG. 2, consider an embodiment of the invention in which the L₁N₁×L₂N₂ switch arrangement is a symmetric switch arrangement. Thus in this embodiment, L₁=L₂=L and N₁=N₂, =N such that the number of ingress subelements of the switch arrangement is Xin=LN, and the number of egress subelements of the switch arrangement 1 is Xout=LN. The LN ingress subelements of switch arrangement 1 are shown aggregated into N ingress aggregations (shown as ingress aggregation elements 2a, 2b, . . . 2n) in FIG. 2. Similarly, the LN egress subelements of switch arrangement 1 are shown aggregated into N egress aggregations (shown as ingress aggregation elements 3a, 3b, . . . 3n) in FIG. 2. The term aggregation and aggregation element are used interchangeably herein to refer to an aggregation of subelements, and may further comprise additional switching sub-structures of the switch arrangement 1 (for example as is shown in FIG. 2 and discussed in more detail below).

As shown in the embodiment of FIG. 2, to implement the channel assignment process according to the invention, a multi-stage switch arrangement is provided. In FIG. 2, only two ingress aggregation elements 2a, 2b are shown each having L1 ingress subelements. Each of the L1 ingress subelements is shown with a plurality of virtual output queues, each of which stores input received by the ingress subelement for a designated output destination. In the embodiment shown in FIG. 2, each of ingress aggregation element 2a, . . . , 2n provides internally three of the switching stages of the switch arrangement. These are shown in FIG. 2 as the 1st, 2nd and 3rd stages of the switch arrangement. The two egress aggregation elements 3a, 3b shown in FIG. 2 each comprise L2 output subelements and internally provide the 5th, 6th and 7th switching stages for the switch arrangement. As shown in FIG. 2, and referred to later herein each switching stage implementing switching in the time domain is denoted by “T”, whereas a switching stage arranged to implement spatial switching is denoted by “S”. Thus in FIG. 2,a seven stage TST S TST switch is shown.

In FIG. 2, the inner stage of the switch arrangement comprises an inner spatial switching stage 4. The inner spatial switching stage comprises L spatial switches 5a, 5b, . . . 5f, which exist in each timeslot of a frame (a frame comprising one or more time-slots). Each of the L spatial switches 5a, 5b, . . . , 5f is provided with N inputs and N outputs. When a frame based scheduling scheme is being implemented, each of the inputs to the switch arrangement (as shown in FIG. 2) will be assigned F channels by the outer switching stages of the switch arrangement. These outer switching stages (shown as the 1st, 2nd, 3rd, 4th, 5th, 6th, and 7th switching stages in FIG. 2) are associated with the ingress and egress aggregations of the switch arrangement as discussed above.

As each switch in the inner switching stage 4 of the switch arrangement exists in each timeslot of the frame (and there are F timeslots in a frame), the number of available channels through the inner time-shared spatial switching stage of the switch arrangement shown in FIG. 2 is LFN. However, rather than assign traffic arriving on each of the Xin=LN ports to the F channels potentially available through a time-shared switch fabric, the invention increases the number of inner channels (i.e. logical middle-stage switches) available through the central spatial switching stage from F to LF (i.e., LF are available to each aggregation element). This is done by creating N aggregation elements, wherein each aggregation element comprises L inputs, and aggregates the LF channels assigned to the L inputs by the outer stages of the switch to form N sets of “aggregated channels”.

This aggregation of the time-space channels which exist within each aggregation element is implemented by performing intermediate switching stages within the aggregation element prior to providing the aggregated channels as input to the inner spatial switching stage of the switch. Effectively this reduces the number of logical ports for which channel assignment is performed through the middle stage switch to just N.

Thus, in FIG. 2, the switch arrangement 1 comprises a plurality of aggregation elements (2a, 2b, . . . 2n, 3a, 3b, . . . 3n) and each aggregation element comprises a time-space-time (denoted TST) switch arrangement. The ingress aggregation elements 2a, . . . , 2n and egress aggregation elements (3a, . . . , 3n) are interconnected by means of inner switching stage 4 (here the central or middle switching stage of the switch arrangement 1). The inner switching stage 4 of the switch arrangement comprises a set of L real switches (also referred to herein as middle-stage switches), each of size N×N, and each of which exists in F timeslots. These middle-stage switches 5a, 5b, . . . , 5f are shown schematically in FIG. 2 as time-shared space switches 5a, 5b, 5c, 5F, . . . , 6F.

Each aggregation element shown in FIG. 2 internally provides switching in both the spatial and time-domain, and thus each aggregation element shown in FIG. 2 forms a switch arrangement sub-structure which itself has a time-space-time (TST) switching structure. Those skilled in the art will appreciate that the switching stages within each aggregation element may be themselves internally structured, so that it is possible for the switch to comprise a number of recursively arranged time-time-space switching structures (for example, a switch arrangement could comprise a time-time-space-time-space-time-space structures) etc. Various permutations of the switching structures of the ingress and egress aggregation elements having both space-and time switching stages are possible in alternative embodiments of the invention.

In the embodiment shown in FIG. 2, each time-switching stage within an aggregation element comprises a plurality of L time-slot interchangers (TSIs), where L is the number of subelements associated with the aggregation element. Thus in the embodiment of the invention shown in FIG. 2, in the first and third (time switching) stages of the switch arrangement 1, L time-slot interchangers are provided which each provide F timeslots for finding a path across the central time-shared space-switching stage of the ingress aggregation (the 2nd stage of the switch arrangement 1). In total therefore, each of the N aggregations of ingress subelements is provided with LF channels. Similarly the LN egress subelements of switch arrangement 1 are logically equivalent into N egress aggregations 3a, 3b, . . . , 3n (not shown). Each egress aggregation comprises a time-space-time switching structure which is implemented in FIG. 2 by L time-slot interchangers in the 5th and 7th (time switching) stages of the switch arrangement 1. Thus each of the N egress aggregations similarly has F timeslots for finding a path across the central time-shared space-switching stage of the egress aggregation (the 6th stage of the transformed switch 1), and so each of the N egress aggregations of egress subelements is provided with LF channels.

In one embodiment of the invention, it is appropriate therefore to consider an initial three-stage switch arrangement as having been transformed into a switch arrangement with an increased number of switching stages, the transformed switch arrangement being configured in a suitable manner to implement the invention. Thus, switch arrangement 1 in FIG. 2 can be considered to have been transformed from a three stage switch having a time-space-time TST switching stage structure (as schematically indicated at the top of FIG. 2) into a seven-stage (TST) S (TST) switch arrangement having a time-space-time (TST) switching stage structure within each of its ingress aggregation elements (the 1st, 2nd, and 3rd stages) followed by an inner-time shared spatial switching stage S (the 4th stage) and a time-space-time (TST) switching stage structure within each of its egress aggregation elements (the 5th, 6th and 7th stages). More generally, however, the channel assignment process can be implemented for any multi-stage switch in which at least one switching stage (on either the ingress or egress side of the switch arrangement) is associated with an aggregation of subelements of the switch arrangement, in which the switch arrangement further has at least one inner time-shared spatial switching stage comprising a plurality of time-shared spatial switches which is adjacent to a said aggregation of subelements.

Returning again to FIG. 2, the inner (central) switching stage 4 of the switch arrangement 1 thus comprises a set of space switches 5, 6 etc, with each space switch 5a, 5b, 5c, 5F being configured in different timeslots. Each space switch 5a, . . . , 5F comprises in total NF time and space channels which are shared between the ingress and egress aggregations 2a, . . . 3n. This inner switching stage 4 therefore provides LNF channels in total. The LF inner channels accessible from each aggregation element through the inner switching stage 4 comprise a common pool of time-space channels, so the inner switching stage 4 should not be confused with a time-space switching stage (for example, which could usually be interpreted as a time stage followed by a space stage).

Thus the time-space aggregated channels are treated as links to the inner-stage switches in a logical 3-stage switch with the aggregation elements providing time-space-time switching sub-networks as first- and third-stage switches. As FIG. 2 shows, there are L real space switches in the inner switching stage 4, each of size N×N and each of which exists in F time slots. The numbers can be generalised to L₁, L₂, N₁ and N₂ for asymmetry as would be apparent to those skilled in the art.

The operation of the channel assignment process for the embodiment of the invention shown in FIGS. 1 and 2 will now be explained in more detail with reference to FIG. 3 of the accompanying drawings.

The channel assignment process can be implemented for any appropriately configured multi-stage switch arrangement, an example of which is shown in FIG. 3. In FIG. 3, a 7 stage TST S TST switch arrangement is shown comprising two ingress aggregation elements 2a, 2b and two egress aggregation elements 3a, 3b. The 2nd and 6th spatial switching stages S of each aggregation element each comprise a array of time shared spatial switches shown schematically for each timeslot by t1, t2, t3, t4 in FIG. 3. Similarly, the time-shared spatial switches of the spatial 4th switching stage S of the switch arrangement are schematically represented in each time-slot by t1, t2, t3, t4.

In one embodiment, the channel assignment process can be implemented for a time-space-time (TST) switch arrangement by transforming the logical structure of the time-space-time TST switch arrangement into a plurality of ingress and/or egress aggregation elements having internal switching sub-structures. Each ingress/egress aggregation element comprises an aggregation of ingress/egress subelements (for example ports or linecards) of the switch arrangement which is further associated (logically and/or physically) with a switching sub-structure, which results in the overall switch arrangement effectively having a higher number of switching stages. Thus, a three stage TST switch arrangement 1 can be considered equivalent to a seven-stage TST S TST switch arrangement, if within each aggregation element a TST switching stage is provided. In such an embodiment, each aggregation element can be considered to comprise a time/space switching sub-structure of the switch arrangement. Within each TST aggregation element, the two time-switching stages are interconnected by an inner switching stage comprising multiple time-shared space switches.

It is possible in other embodiments of the invention to decompose each of the aggregation elements of the switch arrangement into a further time-space-time substructure (TST), for example, to obtain a fifteen stage TST S TST S TST S TST switch arrangement. Iterating this procedure at different aggregation levels effectively enables the channel assignment process to be implemented through each layer of an aggregation element hierarchy. In any hierarchical embodiment, the channel aggregations representing the largest number of channels shared between ingress subelements of switch arrangement are assigned first (i.e., aggregated channel assignment is first performed for the largest aggregation element across the inner stage(s) of the switch arrangement), before channel assignment within an aggregation element occurs. If further sub-structures (i.e., smaller aggregations comprising smaller numbers of ingress subelements (or egress subelements)) exist within an ingress/egress aggregation element, then these will be assigned next, until ultimately an end-to-end channel is generated through the switch arrangement which enables traffic arriving at an ingress subelement of the switch arrangement to be switched through to an egress subelement of the switch arrangement. In this context, an end-to-end channel between an ingress subelement of the switch arrangement to an egress subelement of the switch arrangement comprises at least one channel through an inner time-shared spatial switching stage of the switch arrangement, and at least one channel from/through to an ingress/egress subelement which may include one or more channels through an ingress/egress aggregation element comprising said ingress/egress subelement.

Channel assignment is determined at the highest level of aggregation and then proceeds recursively down through the hierarchy of aggregation levels to assign channels in each smaller aggregation (i.e., in each layer of the time-time-space structure until an end-to-end channel through the switch is determined). Time-slot interchange is implemented at certain time-switch stages (for example, the 1st, 3rd, 5th, and possibly also the 7th stages in the two level hierarchy shown in FIG. 3, to ensure correct contiguity and/or sequencing of traffic at the outputs).

In the embodiments to be described below a channel assignment process may be described with reference to a particular type of traffic, for example, with reference to a switch arrangement 1 suitable for switching packetised traffic (.e.g., packets or cells). Nonetheless, those skilled in the art will appreciate that the channel assignment process described below can be implemented in alternative embodiments in which the switch arrangement is configured to switch traffic having other characteristics, and as such a switch arrangement for switching any particular type of traffic described is described merely as a synecdoche for other switch arrangements for other forms of traffic to which the channel assignment process can be applied. For example, the switch arrangement may comprise a circuit-based switch arrangement, in which TDM channels providing a predetermined bandwidth through the switch arrangement need to be assigned between specific inputs and outputs. Moreover, where reference is made specifically to a particular type of traffic or uses the term input/output/or port, these terms are used as synecdoches for other forms of traffic and other ingress/egress subelements comprising means providing ingress/egress from the switch arrangement.

In FIG. 3, it is assumed that a matching process has already been performed to select certain packets for transmission to their destinations in the next switch cycle, and in embodiments involving other scheduling techniques, it will be assumed that the traffic to be transmitted through the switch arrangement 1 between predetermined ingress subelements and egress subelements has already been decided, with only the specific path through the switch arrangement 1 remaining to be decided.

Thus, for the switch arrangement 1 shown in FIG. 3, in the initial step of the channel assignment process, the LN subelements of switch arrangement 1 are aggregated into N aggregations of subelements. For example, ingress subelements 1 to L are grouped together to form ingress aggregation 2a, ports L+1 to 2L are grouped into ingress aggregation 2b etc. A similar process occurs on the output side of the switch, where the NL egress subelements are aggregated into N egress aggregations of L egress subelements.

In FIG. 3, where a channel assignment scheme is being implemented according to one embodiment of the invention, switch arrangement 1 has been transformed into a multi-stage switch in which the logical switch 1 is firstly augmented with additional time switching stages (for example, provided by time-slot interchangers) in the input and output ports to become a three-stage switch having a time-space-time TST switching structure. This three-stage switch arrangement, is then transformed into a seven-stage (TST) S (TST) switch arrangement, in which each ingress and egress aggregation of ingress and egress subelements respectively comprises a three-stage (TST) switch arrangement. Effectively, each of the aggregations of subelements comprises an outer sub-network of the switch arrangement comprising a three-switching stages. As described above, transformation can be recursively applied again to the aggregation elements of the switch arrangement 1 in some embodiments of the invention.

Time-switching stages, which may for example be implemented by time-slot interchanging in the embodiment of the invention shown in FIG. 3, are provided at alternate stages of the switch arrangement 1, to ensure that the contiguity and sequence of cells is maintained at the egress subelements of the switch arrangement and to prevent cell contention at both ingress subelements and egress subelements. The original switch arrangement 1 shown in FIG. 1 is now represented logically by a seven stage switch arrangement as shown in FIG. 3, having a time-time-space-time-space-time-space (TSTSTST) switching structure, where switches in the first three stages and in the last three stages are aggregated into sub-networks of logical three-stage switches.

Each of the 2N aggregations shown in FIG. 3 is now effectively a sub-network consisting of an L×L space switch (or wavelength switch, for example) which is configured in F different time slots. Effectively, if originally channel assignment is to be implemented for a three-stage switch, then the actual switch arrangement is transformed from three-stage to seven-stages in order to implement the channel assignment. Only the switches in the 1^{st} and 7^{th} stages need to represent the real inputs/outputs (i.e., real ports or linecards for example) of the initial switch arrangement 1, however, and the inputs are configured to have virtual output queues (VOQs) to avoid head of line blocking. The time-switching stages comprising time-slot interchangers in the 3^{rd} and 5^{th} stages can be considered as being either associated with the same real ports or linecards of the initial switch 1 or associated with additional real ports or linecards.

In the embodiment shown in FIG. 3, the 1^{st}, 3^{rd}, 5^{th} and 7^{th} stages of the 7-stage architecture are each shown to have a time-slot interchange capability, however, the 1st and 7th TSI stages need not be explicitly implemented in all embodiments of the invention. As an example of an embodiment where their implementation is optional, the time-slot interchange capability of the 1^{st}-stage can be provided instead by forwarding each cell or packet from the correct VOQ in the correct time slot, which removes the need to implement a first time-switching stage in an ingress aggregation element. The provision of a time-slot interchange capability in the final outer stage of the switch arrangement (for example, the 7th stage of the embodiment shown in FIG. 2 or FIG. 3) is also not required in some embodiments of the invention.

As previously mentioned, in FIGS. 2 and 3 there are L real middle-stage space switches, each of size N×N and each of which exists in F time slots. The aggregation technique has the effect of reducing the number of logical ports for which channel assignment is performed through the middle stage of the switch arrangement to just N (the number of logical aggregations (i.e., sub-networks) of the switch arrangement).

The time slots of each input/output port in each aggregation element providing a sub-network 2a, 2b . . . 3n of the switch arrangement 1 are aggregated into a common pool of FL time-space channels for that sub-network, where F is the number of time-slots which comprise a frame. In this context, a time-slot has sufficient duration to contain a cell or packet at the bit-rate employed. This use of a frame comprising a plurality of time-slots as opposed to a single-time slot process increases the number of available channels which can be assigned to provide a path for whichever particular cells have been matched. Each time-space channel corresponds to a particular time slot through one of the real middle-stage space switches (i.e., one of the switches of the inner time-shared spatial switching stage of the switch arrangement 1), enabling each of the LF time-space channels to be treated as if it were a link to a logical middle-stage switch in a conventional three-stage switching network, the first and third stages of which are the sub-networks of FIG. 2.

Each input and output port of the 3-stage logical switch represents a time slot occupied by an individual cell or packet in one of the spatial input and output ports (respectively) of FIG. 1. Accordingly, for a frame duration of F time-slots and a switch arrangement 1 with LN inputs and LN outputs, the 3-stage logical switch will have LN multiplied by F input ports and LN multiplied by F output ports (i.e. LNF inputs and LNF outputs, or for asymmetric L and N; L₁N₁F inputs and L₂N₂F outputs).

The decomposition of each aggregation element (i.e. each sub-network) of the switch arrangement into a three-stage TST switch removes any conflicts which might otherwise arise if two cells or packets sent or received by any of the L real, spatial switch inputs/outputs of an aggregation element sub-network are assigned to the same time slot through different real middle-stage space switches. Since real inputs/outputs (e.g., input/output ports) have only one transmitter and receiver, they cannot transmit or receive more than one cell or packet in the same time slot (input/output contention). Accordingly, in each logical group of inputs/outputs of the switch arrangement (i.e., within each subnetwork of the switch arrangement), cells or packets from/to the same input/output port must be transmitted/received in different time slots to/from another real output/input (e.g. output/input port or linecard).

Once received, the time-slots may require interchanging to restore the correct cell/packet sequence and provide cell/packet contiguity. The time-slot interchange process itself can comprise any suitable process known to those skilled in the art. If contiguity of outgoing cells or packets from the same VOQ is required, then all 4 stages of time-slot interchanger are required. But if contiguity of outgoing cells or packets from the same VOQ is not required, the last stage of time-slot interchange can be left out; i.e. the real output ports would have no buffers and cells or packets would leave the switch in the time slots assigned to them within the sub-group or sub-network (stages 5 to 7). This could lead to missequencing of cells/packets from the same VOQ, however, mis-sequencing can be prevented very simply by implementing the VOQs in RAM buffers instead of separate FIFO buffers and re-ordering the time slots in which particular cells or packets within the same VOQ are transmitted from the real input ports (linecards) in the 1^{st} stage; i.e. cells or packets would not exit a VOQ in the time order of their position in the VOQ (no longer FIFO) and by not implementing the 1^{st}-stage time-slot interchangers.

Alternatively, mis-sequencing can be prevented by implementing the VOQs in FIFO buffers and reading the cells or packets from their VOQs in FIFO order and re-ordering the time slots in which the cells or packets are forwarded into the switch using 1^{st}-stage time-slot interchangers.

Returning now to FIG. 2, where a frame comprises F timeslots, before channel assignment can be implemented, it is first necessary to assign the LNF inputs and LNF outputs of the network to the cells or packets to be switched in the frame. This does not need to be done for every cell or packet individually. Instead, on the input side of the switch, every ingress subelement (i.e., every real port or linecard in this embodiment) assigns a number of contiguous inputs (i.e. time slots) to the a_{i,j} successfully accepted requests of each of its LN VOQs, i.e. from VOQ a_{i,1} to a_{i,LN}, obtained from a previous matching phase. Similarly, on the output side, every egress subelement j (in this embodiment a real port or linecard) assigns a number of contiguous outputs to the a_{i,j} successfully accepted requests from each of the LN inputs, i.e. from VOQ a_{1,j} to a_{LN,j}.

Again assuming that L₁N₁=L₂N₂=LN for simplicity, when each “connection” path between the input and output subelements across the 3-stage switch arrangement is computed sequentially by a single processor, the computing time (i.e., the number of computational steps) is O(LNF²). Assuming, for example, that the computing time allowed for the time-slot assignment is as much as a full frame of F time slots, i.e. Fτ seconds, where τ is the duration of a time-slot, the processor will require a clock speed O(LNF/τ). This can be greater than the switching capacity of the switch it is controlling, and it is desirable if a clock speed substantially less than the capacity of the switch it is controlling is obtained. The invention seeks to provide a channel assignment process which enables the clock speed to be less than the switching capacity of the switch it is controlling.

According to the invention, a channel assignment process (for example, a path-searching process) is performed firstly through one or more inner time-shared switching stages of a multi-stage switch arrangement. Thus, where a seven-stage switch arrangement is provided, the channel assignment process is first implemented through the inner (middle) stage (4^{th}) switches, by assigning to each aggregation element (equivalent to a sub-group or sub-network comprising a plurality of subelements of the switch arrangement) specific time slots through specific real inner (i.e., middle)-stage space switches (time-space channels). Secondly, each individual aggregation element is path-searched (time-slot assigned) internally.

Any suitable path-searching algorithm can be used, but the computational complexity will be reduced only if the path-search algorithm is able to take advantage of the logical aggregation of the switch inputs/outputs into switch aggregation element sub-structures 2a,2b . . . 3n etc. Although path-searching algorithms for rearrangeably non-blocking switching networks could be employed, where these are not able to take advantage of the recursive nature of the channel assignment hierarchy, for example, if they determine the path from the inputs at the lowest level of the hierarchy rather than the highest, such as, for example, Andresen's algorithm, they do not form part of the best mode of the invention currently contemplated by the inventors.

However, in alternative embodiments of the invention, the individual aggregations of subelements forming the substructures/sub-networks could be path-searched internally using Andresen's algorithm (for example, see Steinar Andresen, “The looping algorithm extended to base 2^{t} rearrangeable switching networks,” IEEE Trans. On Comms., Vol. COM-25, No. 10, 1057-1063 (1977), the text of which is hereby incorporated by reference). Andresen's algorithm uses a mapping between rearrangeably non-blocking Benes networks, which use multiple stages of 2×2 switches, and 3-stage Clos networks. In this embodiment of the invention, an even lower processing capacity requirement may be achieved.

Andresen's algorithm can be implemented sequentially or using parallel processors. In practice, however, an optimum number of parallel processors can be identified which should be employed in order to reduce the processor speed to an acceptable value while achieving an acceptable total processing capacity. As Andresen's algorithm is a rearrangeably non-blocking algorithm, it guarantees that no more than F time slots are required within the sub-groups or sub-networks.

Some embodiments of the invention using different path-search algorithms will now be described.

First Path-Search Through the Inner Switching stage of a Multi-stage Switch Arrangement

In one embodiment of the invention, a single level of parallelism from the parallel path-search algorithm for 3-stage (Clos) networks from WO 01/67802 is employed to assign channels and time slots. Using this algorithm, port processors operate in parallel, each one finding the required number of free, common channels between a pair of input and output ports of the switch arrangement, but the channels themselves are found by sequential inspection.

In this embodiment, the term middle-stage switches is used to refer to the switches forming an inner time-shared spatial switching stage of the multi-stage switching arrangement. Where specific reference is made to a middle-stage switch, those skilled in the art will appreciate that this is a synecdoche for an inner-stage switch of the multi-stage switch arrangement and not a literal reference to a switching stage positioned in the middle of the switch arrangement. Similarly, where the term “port” or “input” or “output” is used, those skilled in the art will appreciate that these terms are synecdoches for any appropriate ingress and/or egress element of the switch arrangement and/or an aggregation element.

The first path-search through the inner-stage switches of the switch arrangement (which is equivalent to the process of assigning LF time-space channels) requires N processors, where N is the number of aggregation sub-structures of the switch arrangement, each of the N processors taking O(NLF) computing steps. Each of the N processors must therefore have a clock speed O(NLF/Fτ)=O(NL/τ) Hz, which is 20 GHz in our example. The ratio of processing capacity to switch capacity is then

$$\frac{ProcessingCapacity}{SwitchCapacity} = \frac{N}{LNB} O ( \frac{NL}{τ} ) = O ( \frac{N}{τ B} ) = O ( \frac{N}{500} ) \qquad eqtn 1$$

which is around a ratio of 0.064.

However, in one embodiment of the invention, another degree of parallelism is provided which further reduces the number of computing steps required in the channel assignment process, without increasing the number of processors too much.

In this embodiment of the invention, each subelement (e.g., port) of an aggregation element possesses n separate processors to perform, sequential searching for free, common channels, each one searching sequentially through only O(LF/n) of the O(LF) channels. All n processors search through their channels simultaneously, i.e. in parallel with each other. Each of the n processor's counts the number of free channels that it finds. Then the individual counts are added sequentially (e.g. by one of the n processors) in O(n) steps. When the sum reaches or exceeds the required number of channels, the adding can stop. The channels found by all the processors before the one that reached or exceeded the required number can be seized and assigned to both the relevant, paired sub-groups or sub-networks.

Alternatively, if they haven't yet been assigned, these n processors associated with the subelements can search again, assign and seize. The processor that reached or exceeded the required number can then search again, stopping when it has found, assigned and seized the last required channel. For this double degree of parallelism in the first path search:

$$\begin{matrix}\frac{ProcessingCapacity}{SwitchCapacity} = \frac{\frac{NnN}{F τ} O ( \frac{LF}{n} + n + \frac{LF}{n} )}{LNB} \\ = O ( \frac{N}{τ B} ( 2 + \frac{{n}^{2}}{LF} ) ) \\ = O ( \frac{N}{500} ( 2 + \frac{{n}^{2}}{LF} ) )\end{matrix} \qquad eqtn . 2$$

Because this ratio increases as the square of the number n of processors performing the sequential search in each subelement, the number n should be as small as possible, If the number n were the optimum number (2LF)^{1/2} for minimising the number of computing steps (256 in our example), then the ratio would become

$$\frac{ProcessingCapacity}{SwitchCapacity} = O ( \frac{N}{500} ( 2 + 2 ) ) = O ( \frac{N}{125} ) \qquad eqtn . 3$$

which is twice as large as its smallest possible value with a small number n, and four times as large as the value with a single sequential processor for each of the N processors. For example, if a maximum processor clock speed of 2 GHz is assumed to be available, then

$$O ( \frac{N}{F τ} ( \frac{LF}{n} + n + \frac{LF}{n} ) ) = 2 GHz \qquad eqtn . 4$$

for which n is 21 in this example. This would lead to a processing/switching ratio

$$\frac{ProcessingCapacity}{SwitchCapacity} = O ( \frac{2.01 N}{500} ) = O ( \frac{N}{250} ) \qquad eqtn . 5$$

In this example, reducing the processor speeds from 20 GHz to a practical value of 2 GHz, by adding the summations of the n processors (adders) sequentially, has only doubled the processing capacity requirement. The resulting ratio for this first path search is just 0.128.

In another embodiment of the invention, a third degree of parallelism is provided which further reduces the number of computing steps required in the channel assignment process. In this embodiment the summations from the n processors (for example, counters or adders) provided for the n ports of each aggregation element are added in parallel, using log₂n stages of a real or a virtual binary tree of processors. If the binary tree of processors is implemented virtually, using the same set of n real processors, using in any of the log₂n stages half the number of processors in the previous stage, then the ratio of processing capacity to switch capacity becomes

$$\begin{matrix}\frac{ProcessingCapacity}{SwitchCapacity} = \frac{\frac{NnN}{F τ} O ( \frac{LF}{n} + {log}_{2} n + \frac{LF}{n} )}{LNB} \\ = O ( \frac{N}{τ B} ( 2 + \frac{n {log}_{2} n}{LF} ) ) \\ = O ( \frac{N}{500} ( 2 + \frac{n {log}_{2} n}{LF} ) )\end{matrix} \qquad eqtn . 6$$

The nlog₂n growth rate in this ratio now allows larger numbers n such as 256 to be employed, in order to reduce the number of computing steps and hence the required processor speeds, without significantly increasing the processing/switching capacity ratio. For n=256, the ratio is just

$$\frac{ProcessingCapacity}{SwitchCapacity} = O ( \frac{2.063 N}{500} ) = O ( \frac{1.03 N}{250} ) \qquad eqtn . 7$$

which is 0.132 for our example, while the processor clock speed reduces to just

$$O ( \frac{N}{F τ} ( \frac{LF}{n} + {log}_{2} n + \frac{LF}{n} ) ) = 165 MHz \qquad eqtn . 8$$

Second Path-Search Through Individual Aggregation Elements of the Multi-Stage Switch

Path-searching (a term which can be considered equivalent to channel assignment and even more specifically in this embodiment, equivalent to time-slot assignment) is next performed within each individual aggregation element of the switch arrangement. There are 2N aggregation elements, each of which is path-searched in parallel using the L port processors in parallel, for example, using the first level of parallelism of the parallel path-search algorithm for 3-stage Clos networks in WO 01/67802. Here, the term port processor refers to a processor associated with an ingress and/or egress subelement of an aggregation element as appropriate.

Each one of these L port processors is assumed to search sequentially through O(F) time slots. Nonetheless, blocking may result in between F and 2F-1 time slots being required in practice. Accordingly, in this embodiment the total number of processors is 2NL, each taking O(LF) computing steps. The processor clock speed required is O(LF/Fτ)=O(L/τ)=640 Mbit/s, which is practicable. The processing/switching capacity ratio is

$$\frac{ProcessingCapacity}{SwitchCapacity} = \frac{( \frac{2 {NL}^{2} F}{F τ} )}{LNB} = \frac{2 L}{τ B} = \frac{L}{250} \qquad eqtn . 9$$

which is 0.128 in this example.

Thus from eqtns.4 and 5 the total ratio of processing capacity to switch capacity is 0.256. For a 10 Tbit/s switch this results in a more acceptable 2.56 Tbit/s.

Referring now to FIG. 3 of the accompanying drawings, a detailed embodiment of the invention will now be described which shows in more detail how path searching (channel assignment) is performed through a multi-stage switch arrangement, with specific reference to a switch arrangement comprising a 7-stage switching architecture for switching packetised traffic. Whilst the switch arrangement shown in FIG. 3 will be described in terms of a packetised traffic, those skilled in the art will appreciate that the principles extend readily to cell switch arrangements and to any other switch arrangements for switching traffic which require a channel assignment or path searching process to be implemented.

In FIG. 3 an embodiment of the invention comprising a 4×4 input-queued cell switch arrangement is shown. The 4×4 switch arrangement has L=2 subelements (here ports) per aggregation element, and accordingly N=2 ingress aggregation elements are provided and N=2 egress aggregation elements are provided. Thus the switch arrangement shown in FIG. 3 has LN=4 ingress subelements and 4 egress subelements (here comprising 4 input ports and 4 output ports respectively) and a frame duration F=4 time slots.

Packets are queued in arrays of virtual output queues (VOQs) at the input of the switch arrangement, each VOQ corresponding to a particular input/output pairing. In FIG. 3, a matching process has previously been performed to determine a matrix of accepted requests for the next frame

$$[ {a}_{2} ( i , j ) ] = [ \begin{matrix}0 & 0 & 1 & 3 \\ 0 & 2 & 2 & 0 \\ 1 & 2 & 1 & 0 \\ 3 & 0 & 0 & 1\end{matrix} ] \qquad eqtn . 10$$

Each matrix element a₂(i,j) represents the number of packets to be taken from each of the VOQs (i,j) at the 4 real inputs (for example ports or linecards) of the switch and switched across the fabric in the next frame to the 4 real outputs (for example ports or linecards). The logical 7-stage switch architecture shown in FIG. 3 has 4 logical input and output ports for each real input and output port, i.e. 16 logical input and output ports altogether. Each one of these represents an individual cell or packet to be switched across the fabric.

FIG. 3 shows schematically the result of assigning the 16 logical inputs and 16 logical outputs of the network to the cells or packets. This is done for every accepted cell or packet individually. On the input side of the switch, every real port or linecard i assigns a number a_{i,j} of contiguous logical inputs (i.e. contiguous time slots) to the a_{i,j} successfully accepted requests of its 4 VOQs. Similarly, on the output side, every real port or linecard j assigns a number a_{i,j} of contiguous logical outputs to the a_{i,j} successfully accepted requests from each of the 4 VOQs destined for it.

In FIG. 3, each cell is identified by three numbers. The first two give the identity of the packet's VOQ i,j and the third number in brackets is the specific identity of the cell or packet in its VOQ. For convenience the position of the cell or packet within its VOQ is used as its specific identity. For example, the HOL packet in VOQ 1,3 is designated 1,3(1). The contiguous packets in the same VOQ could be assigned to the logical input and output ports in any order simply by addressing them using an appropriate pointer rule. However, for convenience, in this example they are assigned in the increasing order of their positions in their VOQ. This has the benefit of associating increasing position in the VOQ with increasing time slot position in the frame when transmitted out to line.

First Path-Search Through Middle-Stage Switches

Any suitable path-search algorithm can be used, but if a path search algorithm is used which operates from the outside of the switch inwards, such as for example, Andresen's version of the looping algorithm, there may be no overall reduction in computational complexity as there will be in effect no reduction in the number of inputs and outputs initially considered.

An example of a path-search algorithm which is able to take advantage of the hierarchical structure of the multi-stage switch arrangement according to the invention is the parallel path-search algorithm for 3-stage switches described in International Patent Application WO 01/67802, the contents of which are hereby incorporated by reference. This parallel path-search algorithm requires N=2 processors in this embodiment. Furthermore, it requires the two ingress aggregations (here comprising the left-hand-side sub-networks of the switch arrangement) and the two egress aggregations (here comprising the right-hand-side sub-networks of the switch arrangement) to be taken in pairs. Each pair is processed by one of the 2 processors. This can be performed simultaneously, in parallel.

For example, pairs (Sₗₕₛ1, Sᵣₕₛ1) and (Sₗₕₛ2, Sᵣₕₛ2) could be processed first. When these have been path-searched, the pairings are changed and path-searching undertaken for the next set of sub-network pairs. For example, one of the sub-networks in the pairings could be incremented by 1 (cyclic pairing). Of course in the present switch embodiment, there is only one other set of pairings possible; (Sₗₕₛ1, Sᵣₕₛ2) and (Sₗₕₛ2, Sᵣₕₛ1). Each processor adds up the total number of accepted requests in the VOQs between the pair of sub-networks it is dealing with. From eqtn.6 the reduced matrix of accepted request numbers between the sub-networks becomes

$$[ a ( {S}_{lhs} i , {S}_{rhs} j ) ] = [ \begin{matrix}2 & 6 \\ 6 & 2\end{matrix} ] \qquad eqtn . 11$$

Each processor then finds the first a(Sₗₕₛi,Sᵣₕₛj) free, common middle-stage switches (time-space channels) that have not already been seized, between the first pair of sub-networks. The search begins from the uppermost, first middle-stage switch. This method provides a degree of traditional “call packing” as is known to those skilled in the art.

Each processor then proceeds to repeat the path-search for its second pairing of sub-networks. The assignment of a middle-stage switch to a particular pair of sub-networks also decides the path through the middle-stage switch. After all the accepted requests have been assigned a middle-stage switch (time-space channel), the processors can assign specific packets to those middle-stage switches. For convenience, packets within the same VOQ are assigned to the middle-stage switches in the increasing order of their positions within the VOQ.

The result of all this is to guarantee that the position sequence of packets within the same VOQ is preserved in the sequence of logical middle-stage switches (time-space channels) assigned to them. This does not mean that the position sequence of packets within the same VOQ is preserved in the sequence of time slots assigned to them through the middle-stage switches (time-space channels), because the sequence of 4 time slots is repeated within the 8 time-space channels.

The paths and cell/packet assignments after the first path-search phase through the middle-stage switches (time-space channels) are shown in FIG. 4. LF=2×4=8 middle-stage switches (time-space channels) are sufficient; none of the 16 “connections” is blocked.

Second Path-Search Through Individual Sub-Networks

Although the individual aggregations (e.g. sub-networks) of the switch arrangement could either be path-searched using parallel path-searching for 3-stage Clos networks or using a rearrangeably non-blocking algorithm such as the looping algorithm or Andresen's algorithm, the paths shown in FIG. 5 have been established using the same parallel path-search algorithm as that used for the first path search. This is performed in a similar fashion to the first path search. Once again none of the 16 “connections” is blocked.

To establish the paths, a reduced matrix of numbers of “connections” [c(S)] is first calculated between the 1^{st}- and 3^{rd}-stage switches of each aggregation element (e.g. sub-network) from the packet assignments on either side of the sub-network, as follows:

$$\begin{matrix}[ c ( {S}_{lhs} 1 ) ] = [ \begin{matrix}2 & 2 \\ 2 & 2\end{matrix} ] & eqtn . 12 \\ [ c ( {S}_{lhs} 2 ) ] = [ \begin{matrix}3 & 1 \\ 1 & 3\end{matrix} ] & eqtn . 13 \\ [ c ( {S}_{rhs} 1 ) ] = [ \begin{matrix}1 & 3 \\ 3 & 1\end{matrix} ] & eqtn . 14 \\ [ c ( {S}_{rhs} 2 ) ] = [ \begin{matrix}2 & 2 \\ 2 & 2\end{matrix} ] & eqtn . 15\end{matrix}$$

These serve a similar role for each sub-network to that of eqtn.7 in the first path search. The identities of the specific cells or packets are then assigned to the middle-stage switches of each sub-network (i.e. the 2^{nd} and 6^{th} stages of the 7-stage logical network).

The packet assignments are now sufficient throughout the network to be able to complete the paths through the 1^{st}-, 3^{rd}-, 5^{th} and 7^{th}-stage switch matrices.

FIG. 6 of the accompanying drawings shows the complete paths assigned to every cell or packet. All packets from the same VOQ are in sequence and contiguous at the logical outputs of the 7^{th} stage, which means that they will be in sequence and contiguous when they are transmitted to line. However, if the 7^{th} logical stage of time-slot interchangers is left out, so that packets can go straight out to line without having to be buffered at the real output ports (linecards), then packet 3,2(1) and 3,2(2) will become out of sequence and lose contiguity, as will packets 1,4(1), 1,4(2) and 1,4(3).

Although loss of contiguity may be acceptable, mis-sequencing may not be. Fortunately, mis-sequencing can easily be prevented, without requiring any additional re-sequencing buffers. The method of prevention is purely algorithmic. At each 7^{th}-stage logical switch, the order in which packets within the same VOQ appear at the input ports of the switch can be used to re-order the time sequence in which the packets must be forwarded from their VOQs in the 1^{st} stage. For example, the packets in VOQ 1,4 appear in the order 1,4(2), 1,4(3), 1,4(1) on the input ports of 7^{th}-stage logical switch 4. The paths taken through the network by these packets, which start at the logical output ports of the 1^{st}-stage switch 1, must be mapped to packets at the logical input ports of the 1^{st}-stage switch 1 whose identities correspond to this order; i.e. 1,4(2)→1,4(1), 1,4(3)→1,4(2) and 1,4(1)→1,4(3). The connections across 1^{st}-stage switch 1 are rearranged to provide this mapping, which of course re-orders the time sequence in which the packets will be transmitted from the 1 st-stage logical switch 1.

FIG. 7 shows the re-ordered packet path assignments for preventing mis-sequencing when the 7^{th}-stage time-slot interchangers are left out; i.e. when there is no buffering in the real output ports (linecards) before transmission to line. Packets 1,4(1), 1,4(2), 1,4(3), 3,2(1) and 3,2(2) have been re-ordered at the logical outputs of the 1st-stage time-slot interchangers 1 and 3. Hence the HOL packet 1,4(1) will be transmitted after packet 1,4(3), which is behind it in VOQ 1,4, and before packet 1,4(2). HOL packet 3,2(1) is also transmitted after packet 3,2(2) in 1^{st}-stage logical switch 3.

In any of the embodiments of the invention where VOQs are used to implement input buffering of the multi-stage switch arrangement, if the VOQs are implemented as FIFO buffers, then the switches of the first stage of time-switching with an aggregation element must be implemented (for example, as time-slot interchangers) so that the sequence of packets can be re-ordered. But if the VOQs can be implemented as RAM buffers instead of FIFOs, then the re-ordering can be performed in the process of reading out the packets from the RAM buffer, so that no additional time-switching stage is required within the aggregation element. This eliminates the requirement for time-slot interchangers in the 1^{st} logical stage of the seven stage switch arrangement shown in FIG. 7. It should be noted that the 7^{th}-stage switches are nonetheless included logically in the channel assignment process (i.e., within a path-searching algorithm), in order to determine the correct sequence in which packets must be forwarded from their VOQs to prevent missequencing. However, there is no need to physically implement this time-switching stage within the aggregation elements of the switch arrangement physically. Moreover, when they are not physically implemented, there is no need to compute the paths through the logical 7^{th}-stage switches.

In some embodiments of the invention, a switch (including a network) arrangement where groups of egress subelements all have the same destination is provided. For example, where a number of egress subelements of the switch arrangement all transmit to the next switch arrangement on the same link in a network. In such circumstances, there is no need to distinguish individual egress subelements forming a group of egress subelements all transmitting to the same destination. By considering such groups of egress subelements as a logical entity, the blocking probability of output contention of the switch arrangement is reduced as the egress subelements can be assigned collectively to all traffic (e.g., all packets in a packet switch arrangement) destined for the same outgoing link. Such an approach has advantages in optical packet networks, in which a number of wavelength channels within the same outgoing fibre link are shared between the cells or packets within the fibre. It does not matter which wavelength channel is used by each individual packet.

Thus the blocking resulting from output contention is reduced by grouping the egress channels receiving traffic with the same destination into a logical entity. The computing complexity of the matching and channel assignment processes may be also reduced. This is because effectively the egress subelements are being aggregated into groups of egress subelements which provide a common (or shared) pool of egress subelements and outgoing channels (i.e., time-slots). To treat a group of egress channels receiving traffic having the same destination as a logical entity, the invention assumes that the L egress subelements (for example, the ports or nodes on the right-hand-side of FIG. 7), constitute an egress aggregation, of which there are N.

If contiguity of the cells or packets is not required when the traffic is transmitted out to line, it is possible to not implement one or more of the switching stages of the egress aggregation physically (i.e., one or more of the stages shown as stages 5,6 and 7 in FIG. 2 and their equivalents in the subsequent Figures need not be implemented physically), as the egress aggregation need exist as a logical entity only. This can be considered in a similar manner to the manner in which the final (7th) stage time-switching stage within each egress aggregation (which is shown in the accompanying drawings as an array of time-slot-interchangers) need not be implemented in a seven-stage switch arrangement such as has been discussed herein above.

If one or more of the switching stages of the egress aggregation are not provided, then the time-slots in which the packets depart from the ingress elements (1st stage switches) can be re-ordered, for example, to enable packets from the same VOQ to be transmitted out to line in the correct relative time-sequence, even though they may be transmitted out to line from different output ports or linecards, i.e. from different egress subelements. In this embodiment it is possible for packets from the same VOQ to depart in the same time-slot from different egress subelements (e.g. from different output ports or linecards), but this need not occur in alternative embodiments of the invention.

Those skilled in the art will appreciate that the number of stages can vary and may depend on the number of levels of aggregation used. For larger switch arrangements it is possible to have a larger number of buffer stages. The invention can be implemented in any suitable form, including any suitable combination of software and/or hardware and the software algorithm may be provided in a form which is distributed amongst several components. The invention may be also implemented as a suite of one or more computer programs. As has been stated above, all references to the term packet should be interpreted as including a reference to the term cell, and other packet-like and cell-like traffic. The term ingress aggregation refers to an aggregation of ingress subelements within which it is also possible to logically associate one or more switching stages and may be referred to herein as an ingress element. However, the term ingress element does not imply a strictly physical structure as the term aggregation is used in an equivalent manner to an aggregation element which may comprise a logical and/or physical substructure or sub-network of the switch arrangement. Accordingly, any reference to aggregation element is intended to include an aggregation of subelements which may be configured in a variety of physical and/or logical forms. Equivalently, the term egress aggregation and/or egress aggregation element used in the context of the egress subelements of the switch arrangement can be considered to include a logical and/or physical sub-structure of the switch arrangement.

Those skilled in the art will appreciate that the invention can be implemented in a switching arrangement where bi-directional elements provide the inputs and/or outputs. The term electronic data refers to both communications related and computer related data. Moreover, where it is apparent to those skilled in the art that certain features described in the context of one specific embodiment can be implemented in other embodiments of the invention, such combinations of features not explicitly described specifically herein are also considered to be implicitly disclosed by this description.

The invention thus provides a multi-stage channel assignment process for an input-queued switch arrangement in a communications network, the switch comprising a plurality of N ingress elements and N egress elements, each of the ingress elements having a number L of ingress subelements and each of the egress elements having a plurality L of egress subelements, the switch arrangement being arranged to have L or more real middle stage space switches of size N×N, and having F or more time-slots, the time-slot assignment process between the said ingress subelements and egress subelements comprising the steps of: aggregating F time slots from each of a plurality L in number of said ingress subelements to form an ingress element having a plurality LF or more in number of time-space channels which are pooled between the L subelements of each ingress element and are pooled between the L subelements of each egress element, wherein each time-space channel corresponds to a different logical middle-stage switch of the packet switch arrangement so that the number of logical input elements and logical output elements for which channel assignment is performed through the middle stage of the switch is N; performing time-space channel assignment through the middle stage of the switch between the logical input elements and the logical output elements; providing time-slot interchange capabilities at the 3^{rd}, 5^{th} and optionally 1^{st} and 7^{th} stages; and performing time-slot assignment between the ingress subelements of the ingress elements and the logical output ports of the 3^{rd} stage switches, and performing time-slot assignment between the logical input ports of the 5^{th} stage switches and the egress subelements of the egress elements.

1. A channel assignment process for a switch arrangement, the switch arrangement being arranged to perform the switching of traffic in both the space and time domains, the process comprising:
receiving traffic along a number of ingress subelements of the switch;
for each ingress aggregation comprising a subset of said plurality of ingress subelements, aggregating one or more time-slots of the ingress subelements comprising said ingress aggregation to form one or more aggregated time-space channels;
assigning one or more inner time-space channels available through at least one inner time-shared spatial switching stage of the switch arrangement to each aggregated time-space channel; and
assigning a plurality of end-to-end time-space channels from the plurality of ingress subelements to a plurality of egress subelements through the switch arrangement after said aggregated channels have been assigned through said at least one inner time-shared spatial switching stage.

2. A channel assignment process as claimed in claim 1, wherein each ingress aggregation further comprises a one or more switching stages forming a switching sub-structure of the switch arrangement.

3. A channel assignment process as claimed in claim 1, wherein said switch arrangement further comprises a plurality of egress aggregations, each egress aggregation comprising a subset of the egress subelements of the switch arrangement and one or more switching stages forming a switching sub-structure of the switch arrangement, wherein for each egress aggregation, one or more time-slots of the egress subelements are aggregated to form one or more aggregated time-space channels.

4. A channel assignment process as claimed in claim 2, wherein at least one switching stage comprises a time-domain switching stage.

5. A channel assignment process as claimed in claim 3, wherein in said step of assigning a plurality of end-to-end channels, traffic received at an ingress subelement is assigned to an end-to-end channel comprising: at least one channel through an ingress aggregation; at least one channel through each of the at least one inner time-shared spatial switching stages of the switch arrangement; and at least one channel through an egress aggregation.

6. A channel assignment process for a switch arrangement as claimed in claim 1, wherein the number of time-space inner channels provided by the logical switches of each of said at least one inner time-shared spatial switching stage of the switch arrangement to each ingress aggregation is equal to at least the number of time-slots that each ingress subelement switches end to end through the switch arrangement multiplied by the number of ingress subelements which form an ingress aggregation.

7. A channel assignment process as claimed in claim 1, in which the channel assignment process is implemented as a frame-based channel assignment process.

8. A channel assignment process as claimed in claim 1, in which said process is further iteratively performed within each ingress aggregation to determine a plurality of end-to-end channels through said ingress aggregation, wherein said inner channels comprise time-space channels provided by the logical switches of at least one inner time-shared spatial switching stage of the ingress aggregation element.

9. A channel assignment process as claimed in claim 3, in which said process is further iteratively performed within each egress aggregation to determine a plurality of end-to-end channels through each said egress aggregation element, wherein said inner channels comprise time-space channels provided by the logical switches of at least one inner time-shared spatial switching stage of the egress aggregation element.

10. A channel assignment process as claimed in claim 1, in which the step of assigning inner time-space channels available through at least one inner time-shared spatial switching stage of the switch arrangement to said plurality of aggregated time-space channels is implemented using N processors, where N is the number of aggregations of ingress or egress elements of the switch arrangement.

11. A channel assignment process as claimed in claim 1, wherein each ingress subelement of the switch arrangement is associated with a plurality of processors arranged to operate in parallel, with each other, each processor finding a number of available channels between an ingress subelement and a switch in the final switching stage of an ingress aggregation, wherein the channels within the ingress aggregation element are found by sequential inspection of the status of channels within the ingress aggregation element.

12. A channel assignment process as claimed in claim 1, wherein each egress subelement of the switch arrangement is associated with a plurality of processors arranged to operate in parallel with each other, each processor finding a number of available channels between a switch in the first switching stage of an egress aggregation and an egress subelement of the switch arrangement, wherein the channels within the egress aggregation element are found by sequential inspection of the status of channels within the egress aggregation element.

13. A channel assignment process as claimed in claim 1, wherein each ingress aggregation of the switch arrangement is provided with one or more processors arranged to operate in parallel with the processors of the other ingress aggregations of the switch arrangement, each processor finding the required number of available aggregated channels between an ingress aggregation and an egress aggregation via the a switch in the final switching stage of an ingress aggregation, wherein the channels are found by sequential inspection.

14. A channel assignment process as claimed in claim 1, wherein each ingress aggregation of the switch arrangement is associated with a plurality of processors arranged to operate in parallel with each other, each processor finding a number of available aggregated channels between an ingress aggregation and an egress aggregation via the inner time-shared spatial switching stage of the switch arrangement, wherein the channels are found by sequential inspection of the status of channels from the ingress aggregation and to the egress aggregation.

15. A channel assignment process as claimed in claim 1, in which each ingress subelement is associated with n separate processors to perform sequential searching for available channels, each processor searching sequentially through their channels in parallel with each other; the channel assignment process further comprising the steps of:
each processor counting the number of free channels it determines are available;
a processor sequentially adding the counts from each individual processor until the sum reaches or exceeds the required number of channels or the summation is completed.

16. A channel assignment process as claimed in claim 1, in which each ingress aggregation is associated with n separate processors to perform sequential searching for available aggregated channels, each processor searching sequentially through their aggregated channels in parallel with each other; the channel assignment process further comprising the steps of:
each processor counting the number of free aggregated channels it determines are available;
a processor sequentially adding the counts from each individual processor until the sum reaches or exceeds the required number of aggregated channels or the summation is completed.

17. A channel assignment process as claimed in claim 1, in which each ingress subelement is associated with n separate processors to perform sequential searching for available channels, each processor searching sequentially through their channels in parallel with each other; the channel assignment process further comprising the steps of:
each processor counting the number of free channels it determines are available; and
a processor or processors adding the summations from the n processors in parallel.

18. A channel assignment process as claimed in claim 1, in which each ingress aggregation is associated with n separate processors to perform sequential searching for available aggregated channels, each processor searching sequentially through their aggregated channels in parallel with each other; the channel assignment process further comprising the steps of:
each processor counting the number of free aggregated channels it determines are available; and
a processor or processors adding the summations from the n processors in parallel.

19. A channel assignment process as claimed in claim 18, wherein the summations from the n processors in parallel are added using multiple stages of a real or a virtual tree of processors.

20. A channel assignment process as claimed in claim 19, wherein the summations from the n processors in parallel are added using log₂n stages of a real or a virtual binary tree of processors.

21. A channel assignment process as claimed in claim 10, wherein the summations from the n processors in parallel are added using multiple stages of a real or a virtual tree of processors.

22. A channel assignment process as claimed in claim 21, wherein the summations from the n processors in parallel are added using log₂n stages of a real or a virtual binary tree of processors.

23. A channel assignment process as claimed in claim 1, in which a plurality of egress subelements receiving traffic with the same destination are treated as a single a logical entity.

24. A scheduling process for a switch arrangement, the switch arrangement being arranged to perform the switching of traffic in both the space and time domains, the process comprising:
receiving traffic along a number of ingress subelements of the switch;
matching traffic at an ingress subelement of the switch to one or more available egress subelements of the switch; and
assigning channels to matched traffic by performing the steps of:
receiving traffic along a number of ingress subelements of the switch;
aggregating one or more time-slots from each of said plurality of ingress subelements to form a plurality of time-space channels which are aggregated by an aggregation of the said plurality of ingress subelements;
assigning inner time-space channels available through at least one inner time shared spatial switching stage of the switch arrangement to said plurality of aggregated time-space channels; and
assigning a plurality of end-to-end time-space channels from the plurality of ingress subelements to a plurality of egress subelements through the switch arrangement after said aggregated channels have been assigned for switching through the said at least one inner time-shared spatial switching stage.

25. A scheduling process as claimed in claim 24, wherein the number of time-space inner channels provided by the logical switches of each of said at least one inner time-shared spatial switching stage of the switch arrangement to each aggregation element is equal to at least the number of time-slots that each ingress subelement switches end to end through the switch arrangement multiplied by the number of ingress subelements which form an aggregation element.

26. A switching process comprising performing steps in the method of scheduling traffic as claimed in claim 24 or 25, and further comprising the step of: switching received traffic along said assigned end-to-end channels from the ingress subelements to the egress subelements.

27. A switching process as claimed in claim 26, in which traffic received by an ingress subelement is switched at least once in the time-domain within an ingress aggregation comprising said ingress subelement before being switched spatially by at least one inner time-shared spatial switching stage of the switch arrangement.

28. A switch arrangement arranged to perform the switching of traffic in both the space and time domains, the switch arrangement comprising:
a plurality of ingress subelements;
a plurality of egress subelements;
means to receive traffic along said number of ingress subelements;
means to store said received traffic;
means to aggregate one or more time-slots from each of said plurality of ingress subelements to form a plurality of time-space channels which are aggregated for an ingress aggregation of the said plurality of ingress subelements; and at least one inner time-shared spatial switching stage, comprising a plurality of logical switches, wherein said plurality of logical switches are arranged to provide a number of time-space inner channels to each aggregation element which is equal to at least the number of time-slots that each ingress subelement switches end to end through the switch arrangement multiplied by the number of ingress subelements which form an aggregation element; and
switch processor means arranged to switch traffic received by the switch arrangement along a plurality of assigned end-to-end channels from the ingress subelements to the egress subelements.

29. A switch arrangement as claimed in claim 28, in which traffic received by an ingress subelement is switched at least once in the time-domain within an ingress aggregation comprising said ingress subelement before being switched spatially by at least one inner time-shared spatial switching stage of the switch arrangement.

30. A switch arrangement as claimed in claim 28, further comprising:
means to assign inner time-space channels available through at least one inner time-shared spatial switching stage of the switch arrangement to said plurality of aggregated time-space channels; and
means to assign a plurality of end-to-end time-space channels from the plurality of ingress subelements to a plurality of egress subelements through the switch arrangement after said aggregated channels have been assigned for switching through the said at least one inner time-shared spatial switching stage.

31. A switch arrangement as claimed in claim 28, wherein the switch is arranged to perform frame-based switching.

32. A switch arrangement as claimed in claim 28, wherein the switch arrangement is provided with storage means to queue traffic at its subelements.

33. A switch arrangement as claimed in claim 32, wherein said storage means is implemented using virtual output queuing.

34. A switch arrangement as claimed in claim 33, wherein the virtual output queues are implemented in random access memory.

35. A switch arrangement as claimed in claim 28, wherein the switch arrangement is arranged to switch cells or packets.

36. A switch arrangement as claimed in claim 28, wherein the switch arrangement includes at least one wavelength switch.

37. A switch arrangement as claimed in claim 28 wherein the ingress subelements and egress subelements are bi-directional.

38. A switch arrangement as claimed in claim 28, wherein the number of ingress subelements is not equal to the number of egress subelements.

39. A switch arrangement as claimed in claim 28, wherein the switch is asymmetric in that the number of ingress aggregations is not equal to the number of egress aggregations.

40. A switch arrangement as claimed in claim 28, wherein the switch arrangement comprises a multi-stage switching structure, wherein within each aggregation of ingress subelements, at least one switching stage is provided.

41. A switch arrangement as claimed in claim 28, wherein the switch arrangement comprises a multi-stage switching structure, wherein within each aggregation of egress subelements, at least one switching stage is provided.

42. A switch arrangement as claimed in claim 28, wherein the switch arrangement comprises a multi-stage switching structure, wherein within each aggregation of ingress subelements, at least one time-switching stage and/or at least one spatial switching stage is provided.

43. A switch arrangement as claimed in claim 28, wherein the switch arrangement comprises a multi-stage switching structure, wherein within each aggregation of egress subelements, at least one time-switching stage and/or at least one spatial switching stage is provided.

44. A switch arrangement as claimed in claim 28, wherein the switch arrangement comprises a multi-stage switching structure, wherein within at least one ingress aggregation of ingress subelements, a first time-switching stage; a spatial switching stage; and a second time-switching stage are provided.

45. A switch arrangement as claimed in claim 28, wherein the switch arrangement comprises a multi-stage switching structure, wherein within at least one aggregation of egress subelements, a first time-switching stage; a spatial switching stage; and a second time-switching stage are provided.

46. A switch arrangement as claimed in claim 28, wherein at least one inner spatial switching stage of the switch arrangement comprises one or more space switches which are shared in time between the ingress and egress aggregation elements.

47. A switch arrangement as claimed in claim 46, wherein traffic is logically switched by the switch arrangement firstly in a time-switching stage within an aggregation element, secondly by a spatial switching stage within an aggregation element, thirdly by a time-switching stage within an aggregation element, fourthly by a time-shared spatial switching stage of the switch arrangement, fifthly in a time-switching stage within an aggregation element, sixthly by a spatial switching stage within an aggregation element, and finally by a time-switching stage within an aggregation element.

48. A switch arrangement as claimed in claim 47, wherein the switch arrangement comprises a plurality of switching stages forming a permutation of said seven time and spatial switching stages.

49. A switch arrangement as claimed in claim 28, wherein the arrangement of one or more time-switching stages provided within each ingress aggregation of ingress subelements and/or each egress aggregation of egress subelements implements one or more of the following:
the prevention of data contention at both the ingress subelements and the egress subelements of the switch arrangement;
the correction of the sequencing of data at the egress subelements of the switch arrangement; and
the provision of contiguity of data at the egress subelements of the switch arrangement.

50. A switch arrangement as claimed in claim 28, wherein at least one time-switching stage within is implemented using one or more time-slot interchangers.

51. A switch arrangement as claimed in claim 28, wherein at least one time-switching stage within an ingress aggregation is implemented using one or more virtual output queues implemented in random access memory.

52. A switch arrangement as claimed in claim 28, wherein the switch arrangement includes parallel processor means arranged to assign said plurality of aggregated time-space channels in parallel to said logical inner channels through the switch arrangement.

53. A switch arrangement as claimed in claim 28, wherein the switch arrangement includes parallel processor means arranged to assign a plurality of time-space channels in parallel to said logical inner channels through an ingress and/or egress aggregation.

54. A switch arrangement as claimed in claim 52, wherein the parallel processor means comprises a tree of processors.

55. A switch arrangement as claimed in claim 28, wherein the switch arrangement is arranged to implement a channel assignment process including the switching of traffic in both the space and time domains, said process comprising:
receiving traffic alone a number of ingress subelements of the switch;
for each ingress aggregation comprising a subset of said plurality of ingress subelements, aggregating one or more time-slots of the ingress subelements comprising said ingress aggregation to form one or more aggregated time-space channels;
assigning one or more inner time-space channels available through at least one inner time-shared spatial switching stage of the switch arrangement to each aggregated time-space channel; and
assigning a plurality of end-to-end time-space channels from the plurality of ingress subelements to a plurality of egress subelements through the switch arrangement after said aggregated channels have been assigned through said at least one inner time-shared spatial switching stage.

56. A network comprising one or more switch arrangements as claimed in claim 28.

57. A suite of one or more computer programs arranged to implement the channel assignment process according to claim 1.

58. A suite of at least one computer programs arranged to implement the scheduling process according to claim 24.

59. A suite of one or more computer programs arranged to implement the switching process according to claim 26.

60. A suite of at least one computer program as claimed in claim 57, at least partly arranged to be implemented in hardware.

61. A scheduling process as claimed in claim 24, including the channel assignment process of including the switching of traffic in both the space and time domains, said process comprising:
receiving traffic along a number of ingress subelements of the switch;
for each ingress aggregation comprising a subset of said plurality of ingress subelements, aggregating one or more time-slots of the ingress subelements comprising said ingress aggregation to form one or more aggregated time-space channels;
assigning one or more inner time-space channels available through at least one inner time-shared spatial switching stage of the switch arrangement to each aggregated time-space channel; and
assigning a plurality of end-to-end time-space channels from the plurality of ingress subelements to a plurality of egress subelements through the switch arrangement after said aggregated channels have been assigned through said at least one inner time-shared spatial switching stage.

62. A switching process according to claim 26, in which traffic is scheduled through a switch arrangement which switches traffic in both the space and time domains and comprises:
a plurality of ingress subelements;
a plurality of egress subelements:
means to receive traffic alone said number of ingress subelements;
means to store said received traffic;
means to aggregate one or more time-slots from each of said plurality of ingress subelements to form a plurality of time-space channels which are aggregated for an ingress aggregation of the said plurality of ingress subelements; and at least one inner time-shared spatial switching stage, comprising a plurality of logical switches, wherein said plurality of logical switches are arranged to provide a number of time-space inner channels to each aggregation element which is equal to at least the number of time-slots that each ingress subelement switches end to end through the switch arrangement multiplied by the number of ingress subelements which form an aggregation element; and
switch processor means arranged to switch traffic received by the switch arrangement along a plurality of assigned end-to-end channels from the ingress subelements to the egress subelements
wherein a scheduling process is implemented to provide a channel assignment comprising:
receiving traffic along a number of ingress subelements of the switch;
for each ingress aggregation comprising a subset of said plurality of ingress subelements, aggregating one or more time-slots of the ingress subelements comprising said ingress aggregation to form one or more aggregated time-space channels;
assigning one or more inner time-space channels available through at least one inner time-shared spatial switching stage of the switch arrangement to each aggregated time-space channel; and
assigning a plurality of end-to-end time-space channels from the plurality of ingress subelements to a plurality of egress subelements through the switch arrangement after said aggregated channels have been assigned through said at least one inner time-shared spatial switching stage.

63. (canceled)

64. (canceled)

65. (canceled)

66. (canceled)

67. (canceled)

68. A channel assignment process for a multi-stage switch arrangement having a plurality of inputs arranged in a plurality of logical associations and a plurality of outputs, wherein time-slotted traffic is received by each logical association of inputs is operated on by one or more switching stages arranged to operate only on traffic provided by the respective logical association of inputs, the channel assignment process comprising:
for each logical association, aggregating the time-slots carrying traffic from the inputs forming said logical association to form a channel comprising a plurality of logically associated time-slots;
determining a path through a spatial switching stage of the switch arrangement arranged to receive a said channel from each of said logical associations of inputs of the switch arrangement; and
determining a path for each time-slot within each logical association such that a plurality of end-to-end time-space channels are provided for one or more inputs of the switch arrangement to their requested output via said channel through said spatial switching stage of the switch arrangement.

69. A channel assignment process as claimed in claim 68, wherein the outputs of the switch arrangement are logically associated with one or more switching stages, and said step of determining a path for each time-slot within each logical association further comprising determining a path within each logical association of the outputs of the switch arrangement such that said plurality of end-to-end time-space channels are provided.
